(19) United States
(12) Patent Application Publication
(10) Pub. No.: US 2025/0131044 A1
(43) Pub. Date: Apr. 24, 2025

(54) SYSTEMS AND METHODS FOR HYBRID MULTI MACHINE LEARNING AGENT ORCHESTRATION

(71) Applicant: HSBC GROUP MANAGEMENT SERVICES LIMITED, London (GB)

(72) Inventors: Jude KEN-KWOFIE, New York, NY (US); Violetta ATOYAN, London (GB); John MERRALL, London (GB); Nathalie TRANDIN, London (GB); Phillip INTALLURA, London (GB)

(21) Appl. No.: 19/007,416

(22) Filed: Dec. 31, 2024

(51) Int. Cl. G06F 16/903; G06F 16/9038

(52) U.S. Cl. CPC G06F 16/90344; G06F 16/9038

(57) ABSTRACT

A hybrid multi-agent orchestration system and methods is proposed where one or more multi-domain primary computational conversation agents are configured to interoperate with a plurality of secondary domain specialized computational conversation agents in query handling. The hybrid terminology refers to a hybrid of primary computational conversation agents and a plurality of secondary domain specialized computational conversation agents that are coupled together in a specific computer architecture designed to enhance the computing capability of both types of agents working together in an effort to improve the accuracy and relevancy of the generated results, albeit at a significantly increased complexity and computational processing cost. The secondary agents can include trained machine learning models having a diversity of data feeds and machine learning architectures.

### FIELD

The present application relates to computer architecture for computer agentic orchestration and more specifically, to systems and methods for hybrid multi machine learning agent orchestration.

### INTRODUCTION

Conversational automated agents can be trained using a base of knowledge to generate response strings responsive to a user's query. However, agents are limited by the training data and the limitations of the underlying agent computing architecture. Accordingly, while they may perform well in a single domain, they may have difficulties performing across multiple domains.

There are limitations of storage capacity, dataset training retention, and catastrophic forgetting is possible. This problem becomes exacerbated as the number of possible domains increases, and also when the queries are in respect of questions that require deep specialist machine learning training.

In these situations, the system may either hallucinate and generate entirely incorrect but seemingly correct responses, generate non-sensical responses, or simply refuse to provide a high confidence output.

### SUMMARY

A technical challenge with conversational agents is that it is difficult to attain conversational relevancy, especially when using either multi-domain or domain-specific conversational agents individually. Multi-domain agents lack sufficient depth to generate contextual responses, while domain-specific conversational agents may be more prone to hallucinations and inaccuracies when responding to a query that is domain adjacent. For example, deficiencies in large language models can be readily apparent when requesting the large language models to conduct more specific tasks, such as suggesting chess moves, and the agent begins suggesting moves that are nonsensical or violate gameplay rules.

A hybrid multi-agent orchestration system and methods is proposed where one or more multi-domain primary computational conversation agents are configured to interoperate with a plurality of secondary domain specialized computational conversation agents in query handling. Effectively, the approach is akin to an “all hands on deck” approach, but instead of humans, conversational agents are queried instead. In an effort to avoid hallucinations or incorrect responses, in some embodiments, a human in the loop can be incorporated in a review pipeline of the responses, for example, as an automated review cycle, where the review output is generated, but is gated for review before output.

The hybrid terminology refers to a hybrid of primary computational conversation agents and a plurality of secondary domain specialized computational conversation agents that are coupled together in a specific computer architecture designed to enhance the computing capability of both types of agents working together in an effort to improve the accuracy and relevancy of the generated results, albeit at a significantly increased complexity and computational processing cost. Accordingly, the approach proposed herein is particularly useful in a situation where accuracy is very important, or there are already existing trained agents that have been configured for narrow domain-specific tasks that can be coupled to the system for generating candidate responses.

The human-in-the-loop as a final check can be utilized as a final accuracy review, recognizing that automated agents may be prone to hallucinations. In the primary/secondary agent architecture, the hallucination risk is compounded because either or both of the agents can generate incorrect results, and as noted herein, the generated responses can include metadata records indicative of data lineage so that even if the data is being remixed and combined together, the data lineage is still available and provided to the human-in-the-loop to review. The risk is especially compounded when the output from the primary agent is then used to generate a visualization output, which can include graphical items such as pie charts, bar charts, summarizing and aggregating data, and then presenting an automatically generated summary. For example, a human-in-the-loop can then use anchor points identified in the generated output as interactive hyperlinks to underlying data repositories or primary sources of data to validate a presented data element. The human-in-the-loop is not only useful for hallucination risk, but the human-in-the-loop, using the lineage data, can check against recency of the data to ensure that it is the appropriate data for the query. For example, a type of inaccuracy can include a query about a very specific timeframe or a very recent timeframe, and an agent that is trained only on aggregate data not related to the timeframe (or not as recent) makes a high confidence but incorrect output. The lineage data is never generated using a machine learning model as it is a direct record of the data feeds and datasets used to train an agent or supplied to the agent as an input, and thus has high reliability.

As described in some variant embodiments herein, the secondary domain specialized computational conversation agents can benefit from a diversity of different training approaches and architectures, even if the secondary domain specialized computational conversation agents specialize in a same domain. For example, even if the secondary domain specialized computational conversation agents are designed for generating responses based on, for example, Cybersecurity incident response data, two separate agents may have different architectures with different representations for machine learning memory, and thus generate different responses that may be useful in different circumstances during inference.

The multi-domain primary computational conversation agent is a machine learning model based conversational agent that is trained on tailoring queries and generating outputs based on user type and user profile fields. The multi-domain primary computational conversation agent receives a main query string, stringQuery, from a user having a user type and user profile fields. The multi-domain primary computational conversation agent broadcasts a subquery message to the secondary domain specialized computational conversation agents, and receives one or more response data messages from each of the secondary domain specialized computational conversation agents, each data message including a combination of a proposed response string, stringResponse[n], and a corresponding confidence score, floatConfidence.

The multi-domain primary computational conversation agent processes each of the stringResponses[n], and floatConfidence and generates a floatUserScore for each response based on the model's scoring based on the user type and user profile fields from the querying party. The multi-domain primary computational conversation agent then re-generates an output based on one or more of the highest ranked stringResponses[n] based on the user type and user profile fields.

A non-limiting example use case described herein relates to a specially configured system for hybrid multi machine learning agent orchestration for handling Cybersecurity-related queries.

In this example, the hybrid multi-agent orchestration system is configured to serves as a computational “chief of staff” that is able to adapt the user's query to generate sub-queries to individual specialist agents, that can have a diversity of skills and training. From a computational perspective, the diversity of skills and training can include differences in computational architectures, data feed (and variations thereof) so that agents represent different perspectives with different breadth/depth characteristics, as well as long/short term memory and recognition aspects.

The primary agent may also be tasked with privacy/privilege based cleaning of the responses to ensure that there is no information leakage that breaches a privilege/privacy consideration. Furthermore, due to the multi-domain and domain-specific expertise segregation, there may be secondary agents that are trained and tuned to track second/nth order events, such as situational change, acceleration, which allows for a greater level of machine learning analysis.

In another variation, it is possible to have multiple versions of a query having different query perturbation or tokenization parameters elicit more responses (e.g., 3 secondary agents get sent 3 variant sub-queries spawned from the main query so that the primary agent gets back 9 results instead). In another variation, where there are a large number of secondary agents, the primary agent can be configured to conduct a first selection process where among hundreds or thousands of secondary agents, the primary agent may not sub-query all of them every time and only query a selected batch which may be selected at random or based on a selection pre-process.

In another variation, the primary agent could essentially maintain a query for a period of time as a persistent query, and spawn sub-queries periodically to identify changes or to update a dashboard periodically, or identify major changes for alerting the user (e.g., major incident in data center 5, data center 5 breached and a shutdown process was automatically initiated. All comms impacted in EMEA).

The generated output, in some embodiments, can be based on a combination of one or more secondary agent responses, transformed by the primary agent or a coupled visualization agent that is configured to generate visualization outputs such as graphical user interface renderings that can be generated specific to a user type or user preferences, along with underlying metadata about the agents and/or the sub-queries used, as well as the underlying “data lineage” supporting the generated response. For example, let's say Agent 1 has a weekly data feed of aggregated incident reports, and Agent 1's response was ultimately presented in some fashion to the chief risk officer. This level of generated information and customized information may be presented such that a user is also able to investigate into the underlying data of a generated dashboard to conduct additional investigation. As noted above, the underlying metadata data lineage, while it can be provided as an input signal into the primary agent for consideration alongside the original query (especially useful if the original query has a temporal aspect to it, e.g., “What is the Company's current stance on remediating Log4Shell vulnerabilities?), it can also be provided to a human-in-the-loop as reference data object for final approval. In an applied, practically integrated example, the human-in-the-loop provides a final sanity check to help ensure that the result is accurate and useful.

The foregoing has outlined the features and technical advantages in order that the detailed description that follows may be better understood. Additional features and advantages will be described hereinafter. It should be appreciated by those skilled in the art that the conception and specific embodiment disclosed may be readily utilized as a basis for modifying or designing other structures. It should also be realized by those skilled in the art that such equivalent constructions do not depart from the spirit and scope of the embodiments described herein. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the embodiments described herein.

### BRIEF DESCRIPTION OF THE DRAWINGS

For a more complete understanding of the disclosed methods and apparatuses, reference should be made to the implementations illustrated in greater detail in the accompanying drawings, wherein:

FIG. 1 is an example diagram showing, on the left hand side, different types of stakeholders that may be submitting queries, and on the right hand side, a multi-agent system as proposed herein, according to some embodiments.

FIG. 2 is a block schematic showing an example system architecture for hybrid multi machine learning agent orchestration, according to some embodiments.

FIG. 3 is a computational architecture diagram showing an example functional stack for implementing the hybrid multi-agent orchestration system, according to some embodiments.

FIG. 4 is a computational architecture diagram showing an example query handled across the system of FIG. 2, according to some embodiments.

FIG. 5 is a pictogram showing example response strings generated by different computing agents, according to some embodiments.

FIG. 6 is a pictogram showing a variant embodiment where iterative analysis is utilized for query replay and scenario tracking, according to some embodiments.

FIG. 7, FIG. 8, FIG. 9 are example user interface screens, according to some embodiments.

FIG. 10 is a block schematic showing an example machine learning/artificial intelligence network architecture, according to some embodiments.

FIG. 11 is a block schematic diagram illustrating the functional components of an example data intake engine, according to some embodiments

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

A hybrid multi-agent orchestration system and methods is proposed where one or more multi-domain primary computational conversation agents are configured to interoperate with a plurality of secondary domain specialized computational conversation agents in query handling. Effectively, the approach is akin to an “all hands on deck” approach, but instead of humans, conversational agents are queried instead. The hybrid terminology refers to a hybrid of primary computational conversation agents and a plurality of secondary domain specialized computational conversation agents that are coupled together in a specific computer architecture designed to enhance the computing capability of both types of agents working together in an effort to improve the accuracy and relevancy of the generated results, albeit at a significantly increased complexity and computational processing cost. Accordingly, the approach proposed herein is particularly useful in a situation where accuracy is very important, or there are already existing trained agents that have been configured for narrow domain-specific tasks that can be coupled to the system for generating candidate responses.

The hybrid multi-agent orchestration system is configured to handle different query strings generated by different individuals and have them handled by a multi-layered combination of conversational agents that are configured to interoperate with one another. Effectively, the system as a whole is technically configured to operate as a “chief of staff” cross-domain agent processing engine that issues sub-queries to domain specialist automated agents, receives the sub-query responses, transforms them into a curated response string, and then generates a query response data object that is presented back to the querying party through a user interface. In an embodiment, the query response data object is first transformed into a graphical user interface rendering set of visualization data objects based on identified preferences of the user or based on a user-type description of the user.

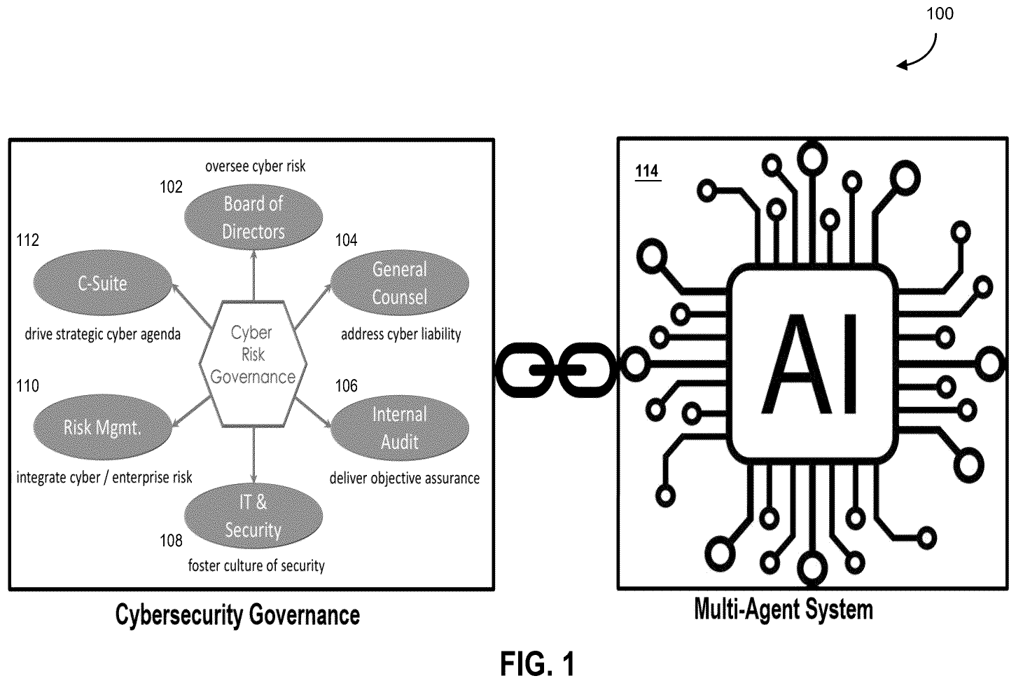

FIG. 1 is an example diagram 100 showing, on the left hand side, different types of stakeholders that may be submitting queries, and on the right hand side, a multi-agent system as proposed herein, according to some embodiments.

A non-limiting Cybersecurity example is shown. Per the ISO/IEC 27001 standard, cybersecurity governance pertains to the component of governance that addresses an organization's reliance in cyberspace in the face of adversaries. It involves directing and controlling security governance, specifying the accountability framework, and providing oversight to ensure effective risk mitigation. Thus, cybersecurity accountability is taken very seriously by many organizations operating in various industries. This accountability underscores a shift required from viewing cybersecurity solely as a technical or operational issues to recognizing it as an enterprise-wide risk management concern. This concern requires organizations to accurately demonstrate and provide correct evidence of their cyberspace positioning in a timely manner. Seamless and dynamic provisioning of organizational cyberspace information and insights is required to enable the business function to make correct decisions in a challenging cyber environment. Accurate and timely analysis, reporting, and decision-making requires establishment of historic and current state, creation and update of all cybersecurity standards, policies, and processes. Stakeholders are required to approach cybersecurity from an enterprise-wide lens, increasing cybersecurity awareness and training, using data that is monitored, measured, analyzed from different data sources and perspectives, and then to generate reports and make suggestions for process improvement.

Accordingly, there can be queries generated by different user-types, such as the board of directors 102, the general counsel 104, an internal auditor 106, IT & security specialists 108, risk managers 110, and corporate executives 112. Even if a same query is submitted, the response may need to be tailored based on what the user-type or user is tasked with actioning based on the information. For example, corporate executives 111120 may be tasked with setting overall strategy policy and agenda, while IT & security specialists 108 may be tasked with implementing the overall strategy policy and agenda by conducting specific tasks. For example, a specific type of zero day vulnerability may be identified, and a query relating to the zero day vulnerability by the corporate executives 110 may generate outputs with dashboards and overall vulnerability levels as well as specific recommendations for remediation. On the other hand, for IT & security specialists 108 may require specific lists of computing end points and packages to update, deprecate, or quarantine. A technical challenge with conversational agents is that it is difficult to attain conversational relevancy, especially when using either multi-domain or domain-specific conversational agents individually. Multi-domain agents lack sufficient depth to generate contextual responses, while domain-specific conversational agents may be more prone to hallucinations and inaccuracies when responding to a query that is domain adjacent. For example, deficiencies in large language models can be readily apparent when requesting the large language models to conduct more specific tasks, such as suggesting chess moves.

A multi-domain primary computational conversation agent 114 is a machine learning model based conversational agent that is trained on tailoring queries and generating outputs based on user type and user profile fields.

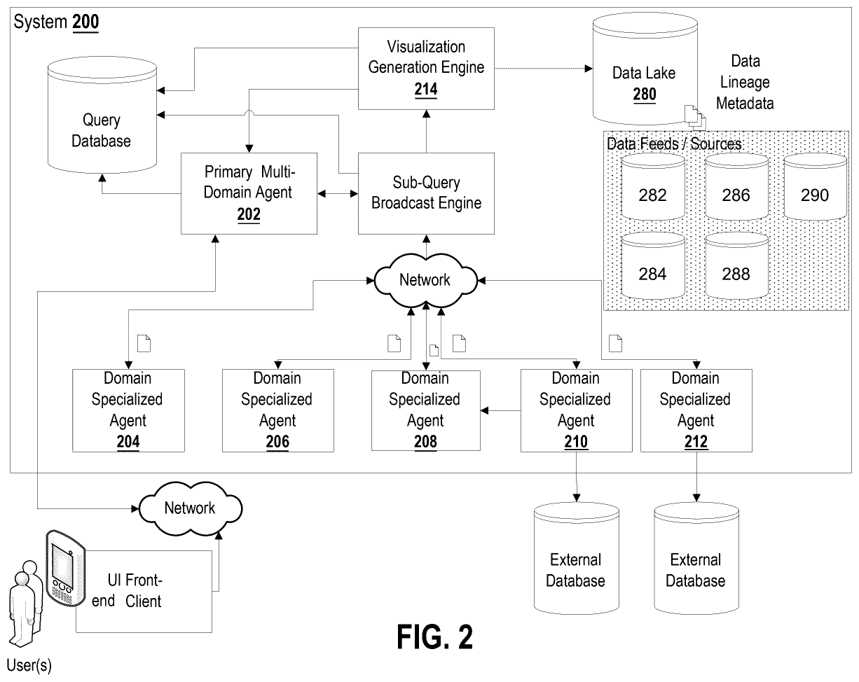

FIG. 2 is a block schematic showing an example system architecture for hybrid multi machine learning agent orchestration, according to some embodiments.

In the example, organizations facing the cyberspace accountability challenge have spent significant time, money, and effort collecting, collating, processing, analysing, and reporting information and insights to support the business functions decision-making process, and these can be stored in a data warehouse or data lake 280, which receives data streams or feeds from data sources 282, 284, 286, 288, 290, and so on. The data in data warehouse or data lake 280 result from efforts from a vast cyberspace data environment focused on the organizations' networks, machines, databases, humans, procedures, and processes. These data areas can be grouped into domains such as: policies & standards, cyber governance published materials, threat intelligence, vulnerability management, incident management, operational metrics, change management, human resources, cost recovery & resource allocation, asset & inventory, service management, among others.

Organization investments made to address cyberspace accountability can result in an ineffective and inefficient use of company resources (i.e., people, time, budget). It is not uncommon for organizations to develop in-house or purchase COTS Governance applications to this end. Organizations struggle to gain a favorable ROI with these investments due to: poor communication of the value of cybersecurity in business terms, challenges with responding to different stakeholders with varying concerns and interests, in-house or cots applications being readily available and producing consistently for all stakeholders, having varying information security organizational structure and responsibilities making it difficult to standardize governance business analysis, reporting and decision-making, among others.

Deficiencies with a legacy approach that to governance which is focused on tracking what is being done vs. how well it is being done, having one size fits all vs. adaptable domain-based and context-aware analysis, reporting, and decision-making, and all SME hands on deck vs. independent on-demand analysis, reporting, and decision-making yield to inefficiencies. Furthermore, there may also be issues with the collection and presentation of information and insights across a broad data environment. In a highly regulated environment, organizations need to ensure they are cognizant of previously articulated positions on a subject. This is important to ensure clear and consistent messages are presented to our internal and external stakeholders to maintain their confidence in the governance approach.

Accordingly, it is imperative to provide an automated system that is configured to collecting and interpreting technical information from across multiple information domains to be able to respond to business queries in terms that are automatically adjusted to improve understandability can easily understand, without being reliant on organization technical subject matter experts (SMEs) to provide and interpret data. A further objective is to ensure synchronicity and alignment of information and insights with the gathering of information from multiple data sources, and to reduce time spent on capturing and analysis data and cycles wasted tracking and reporting efforts.

When in crisis, organizations may attempt to get “all SMEs hands on deck”, but the cost and disruption of “all SMEs hands on deck” analysis can limit the depth, breadth, and frequency of the information organizations can provide to the business function requiring information urgently.

In the system architecture shown, the system 200 can be used as a hybrid multi machine learning agent conversational system that is adapted for addressing queries, such as the queries provided in cybersecurity example above. The proposed system 200 is configured to enables enterprises challenged with accountability to more readily access information, cluster historic and current state, and obtain support in intelligent analysis, reporting and decision-making by using the domain-based and context-aware AI-driven multi-agent system 200. This approach, in an increasingly challenging threat landscape, supports discussions with regulators and board members, demonstrating and evidencing correct governance of accurately and timely within an organization. The proposed system can be integrated with distributed data/query processing engines, which provide processing in parallel, lower-cost performance, and resilience and reliability.

In the proposed system 200, a primary multi-domain primary computational conversation agent (or agents in some variations) 202 receives a main query string, stringQuery, from a user having a user type and user profile fields. The multi-domain primary computational conversation agent 202 broadcasts a subquery message to the secondary domain specialized computational conversation agents 204, 206, 208, 210, 212, and receives one or more response data messages from each of the secondary domain specialized computational conversation agents 204, 206, 208, 210, 212, each data message including a combination of a proposed response string, stringResponse[n], and a corresponding confidence score, floatConfidence.

The multi-domain primary computational conversation agent 202 processes each of the stringResponses[n], and floatConfidence and generates a floatUserScore for each response based on the model's scoring based on the user type and user profile fields from the querying party. The multi-domain primary computational conversation agent 202 then re-generates an output based on one or more of the highest ranked stringResponses[n] based on the user type and user profile fields.

The output can be provided to an optional visualization generation engine 214 that uses field parameters associated with a particular user or user-type to render one or more user interface outputs based on the output data structure. In some embodiments, the multi-domain primary computational conversation agent 202 is configured to provide a parallel track of data source metadata coupled to the output data structure so that the optional visualization generation engine 214 can generate a visualization output based on the provided data source metadata to aid in future investigation of the data underlying a particular visualization. The optional visualization generation engine 214 can be used to “build a document” based on the responses. For example, the specific responses provided back can be consolidated together first by statistically determining correlation between paragraphs and confidence % based on word matching, and then using these to build a document from paragraphs of the response, using each of the specific responses as a data source.

In some embodiments, the “build a document” feature further includes tracking the data lineage of the underlying data by generating an additional metadata file compiled from the metadata logs of each of the combined responses, such that a user is able to see the most likely source of a particular element of information and also traverse links to the specific underlying data lake 280 data element or data feed for further investigation. This is a useful feature to allow for the investigation of potentially spurious connections or anomalies (which in cybersecurity scenarios could be a breach, or simply an aberration, but it is hard to identify a priori). During the “build a document” process, as an input includes the user's description and/or profile type, the document output, such as a dashboard, is automatically customized for the user. For different users, different information is prioritized and surfaced or summarized, even if the same responses are being consolidated together. For example, the same best responses are consolidated together as they were both the highest confidence results as well as the results that were ranked highest from a relevance perspective by the master agent. However, how they are presented can vary drastically.

The visualization generation engine 214 is configured to generate specific dashboards for the user using the consolidated input, and the types of dashboards and configuration of the dashboards are automatically determined as part of the generation process by visualization generation engine 214. A data architect, by virtue of a text based description of the roles and responsibilities, may be interested in modifying code package dependency to remove a dependency on a compromised package, and then generating a patch to do so. A IT technician, similarly, may be interested in patching individual endpoints. The visualization generation engine 214 uses their role and responsibility definitions to generate customized outputs, such as a dashboard designed to track dependency weaknesses for data architect, while for the IT technician, a dashboard showing patched, unpatched endpoints, and a patching progress chart. In an alternate embodiment, the multi-domain primary computational conversation agent 202 despite receiving the same responses, may be configured to consolidate them differently using the roles and responsibilities data as an input when generating an intermediate output to provide to the visualization generation engine 214. This can be useful in situations where depending on a particular user sending a query, the most “accurate answer” may vary greatly depending on their role and responsibilities, and generating a tailored answer and using that for visualization generation engine 214 can help with the relevance of the generated output from the visualization generation engine 214.

The proposed approach is adapted to allows the stakeholders accountable to analysing, reporting, and making decisions to request and receive information, insight and context from across a company's estate through a simple modern user portal having visualization outputs generated by the optional visualization generation engine 214. The tiered hybrid multi-agent approach allows the company to take full advantage of the benefits of a distributed data processing and querying system, which includes, but is not limited to: optimized functionality, parallel processing, lower-cost performance, while providing resilience and reliability using local data access from local data sources or transformed variations thereof. While the system requires computational costs and resource usage in respect of research and development, once operational, the system can decrease the time spent by the engineering team learning and integrating a modern governance accountability tool into a computing environment by adapting and coupling existing domain-specific trained machine learning models.

In some embodiments, the multi-domain primary computational conversation agent 202 is configured to maintain historical preference data and correlates historic responses to board members, regulators, and IT auditors' inquiries to the present truth on the “ground” in a number of different visualizations and variations of depths of output. By tuning the output automatically, the system can be better adapted to addresses uncertainty with how best to respond to inquiries or to decide across hierarchy of decision points from IT, CISO, Executive Team, and Board of Directors, among others.

An automated process for the ingestion, transformation, enrichment, and storage of environment logs and published materials can be maintained in a cloud-agnostic distributed data/query processing system, such as a data warehouse or data lake 280, which receives data streams or feeds from data sources 282, 284, 286, 288, 290. The secondary domain specialized computational conversation agents 204, 206, 208, 210, 212 are configured as domain-based and context-aware AI-driven multi-agent systems that each attempt to support query handling analysis, reporting and decision-making, and each of the secondary domain specialized computational conversation agents 204, 206, 208, 210, 212 can be configured to take different approaches for learning, adaption, communication, and action recommendations based on a diversity of training approaches and computing architectures.

A benefit of having a plurality of different secondary domain specialized computational conversation agents 204, 206, 208, 210, 212 is that they are all trained to access or use information from data sources differently, and are thus provide different perspectives for translating complex technical data from multiple sources across the entire environment, addressing limitations with cross-domain capability while also attempting to have domain-specific capability. While maintaining a multiplicity of agents can be costly from a computational architecture perspective, the proposed approach is useful to improve the level of insight and information delivery to stakeholders.

By using a plurality of secondary domain specialized computational conversation agents 204, 206, 208, 210, 212, in some embodiments, an additional model controller network is provided that specifies how AI multi-agents learn, adapt, communicate, act, and make decisions specific to particular tasks, and a divergence in architectures, training approaches, data feeds, and storage can intentionally be established so that the secondary domain specialized computational conversation agents 204, 206, 208, 210, 212 automatically generate a diversity of outputs that are distinct at one another, attempting to emulate a diversity of subject matter expert viewpoints. As the secondary domain specialized computational conversation agents 204, 206, 208, 210, 212 collect, interpret, and present real time data positions from the entire environment, they can be configured to intelligently identify and proposed approaches for resolving data dependencies based on their specific configurations as information domain AI agent models.

The model controller network is coupled to each of the secondary domain specialized computational conversation agents 204, 206, 208, 210, 212, and is specially configured to orchestrate how each of them are trained, their instantiated architectures, hyperparameters, and variant snapshots. The model controller network can be configured to swap in and out different underlying trained model architectures, modify training processes/curricula, modify data set feeds that are being used as inputs, among others. The model controller network makes it possible to run, manage, and scale multiple parts of AI models independently in the context of one application, with much greater control over individual pieces and life cycles. For example, even for each of the secondary domain specialized computational conversation agents 204, 206, 208, 210, 212, there may be different variations with different model architectures (e.g., transformers, CNNs, RNNs, LSTMs, different gate configurations, different storage configurations), and the model controller network can be configured to modify the configuration or each of the secondary domain specialized computational conversation agents 204, 206, 208, 210, 212 so that a diversity of different outputs can be generated to improve the overall domain-general yet domain-specific utility of the system. For example, if all of the secondary domain specialized computational conversation agents 204, 206, 208, 210, 212 generated similar responses, there would be much reduced utility of the proposed architecture.

The model controller network can deliberately perturb hyperparameters during inference or training operation of the secondary domain specialized computational conversation agents 204, 206, 208, 210, 212 in an effort to maintain a diversity of response types. For example, the secondary domain specialized computational conversation agents 204, 206, 208, 210, 212 responses can be analyzed periodically for correlation, and when correlation is too high, the model controller network can deliberately re-train or modify operation of the secondary domain specialized computational conversation agents 204, 206, 208, 210, 212 to enforce a diversity of response types, as indicated by a correlation analysis. The perturbations can be conducted by injecting noise into the operation or hyperparameters, for example.

The additional model controller network allows the agents to operate autonomously with decision-making traits, interacting and collaborating to form a self-organized system. Because of the different architectures, each agent can thus take actions independently based on its own internal state and information it receives from its surroundings, designed for achieving different specific goals based on optimization functions and update architectures. In another variant, the agents can interact with each other and potentially with their environment. These interactions can be cooperative or competitive, and they often involve the exchange of information or resources. By enabling multiple agents to work concurrently on distributed tasks, they accelerate problem-solving processes, surpassing the capabilities of single-agent systems. Similarly, collective decision-making by multiple agents reduces errors, ensuring more reliable and precise outcomes than individual agent systems.

The multi-domain primary computational conversation agent 202 acts as a master agent that can, for example, use a large language model to consolidate and tailor specific received messages, using the domain-specific responses to address the weaknesses and deficiencies of the large language model, which can be non-specific and also produce noise. Accordingly, by only having the large language model receive domain-specific inputs, this approach can tune/tailor organizational data so context is more accurate and less muddled by extraneous information not related to organization. The specific agents are trained on specific organization knowledge so that have been configured to adapt to language, intent, context and issues specific to an organization's governance, risk and compliance.

Different agents can have different synchronization/data feed/training periodicities and different levels of processed data (from raw data all the way to aggregated data) to take advantage of a diversity in training outcomes so that a diversity of responses can be elicited from each of the secondary domain specialized computational conversation agents 204, 206, 208, 210, 212. This allows the system, for handling a particular query, for example one that straddles multiple domains or requires a specific balance of breadth and depth in response to utilize context even outside of a deliberate focus area. The multi-domain primary computational conversation agent 202 assists in ranking, interpreting, collating, and ultimately translating the received responses into the response to the user that is tailored for the particular stakeholder. In applied enterprise computing examples, the data lake 280 can include such a large amount of data that it is very difficult to sift through all of the data without immense amounts of storage, and accordingly, each of the secondary agents is designed so that they can capture and process a snapshot that is assigned to them. The data lake 280 is configured for automatically conducting ingestion, transformation, enrichment, and storage of Cybersecurity environment logs and published materials in a cloud-agnostic distributed data and querying processing system, for example.

Accordingly, in response to a single question that is posed in plain language, the secondary domain specialized computational conversation agents 204, 206, 208, 210, 212 each generate contextually aligned responses based on AI generated insight from their specific configurations. The system 200 operates as a query-able, ‘any user’ accessible tool that supports iterative and repeatable analysis of the entire environment (including historical data records) to support queries related to support different types of decisions without a need for organization human resources and subject matter experts. The primary multi-domain primary computational conversation agent 202 is configured as a main master agent that automatically processes the sub-query responses to generate an adapted output, reducing the reliance on organization human resources and subject matter experts to collect and interpret data, and to translate technical perspective into friendlier terms.

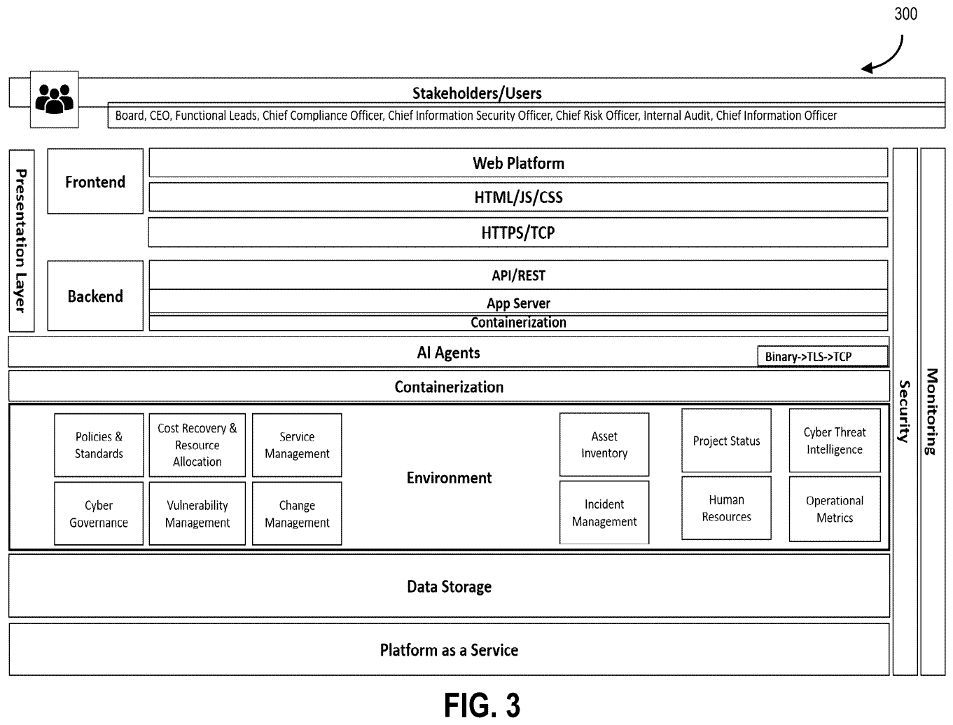

FIG. 3 is a computational architecture diagram showing an example functional stack for implementing the hybrid multi-agent orchestration system, according to some embodiments. The functional stack 300 shows an example practical implementation of the system of FIG. 2 for usage in an enterprise computing environment. As shown in FIG. 3, the various agents are artificial intelligence agents that can be instantiated using different computing environment technologies, such as being instantiated in individual containers operated on a computing backend that are trained differently or have different architectures that are interfaceable through API/REST interfaces exposed through an application server backend. The AI Agents of FIG. 3 can interoperate with a human-in-the-loop as a reviewer, as described in various embodiments herein, where the human-in-the-loop acts as a reviewer of the final generated output and is also provided data lineage metadata for investigation and confirmation of the accuracy of the generated output.

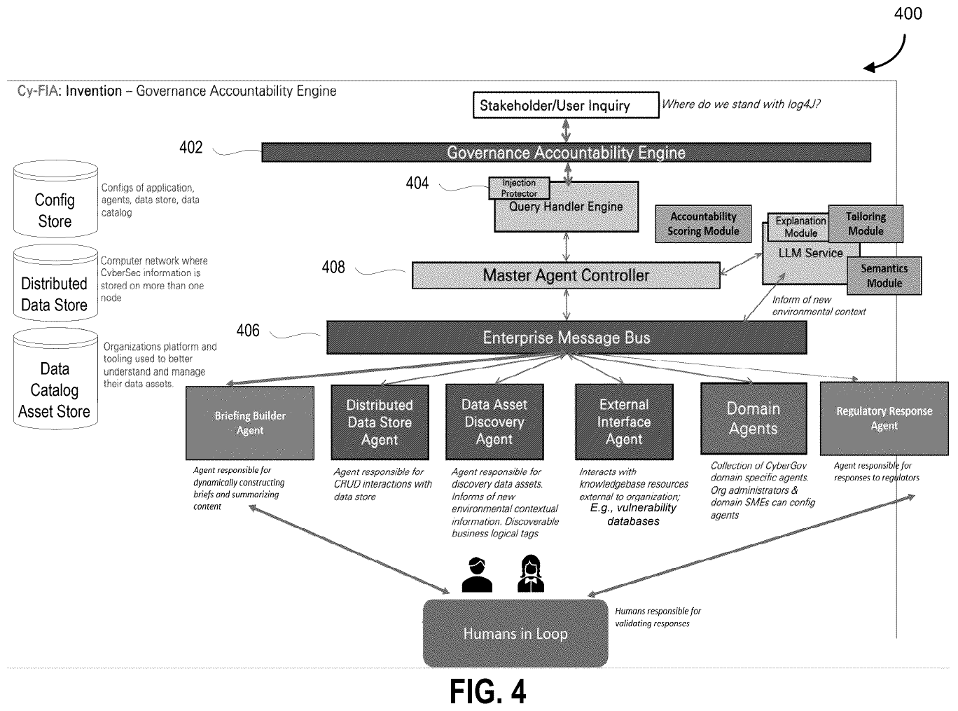

FIG. 4 is a computational architecture diagram showing an example query handled across the system of FIG. 2, according to some embodiments.

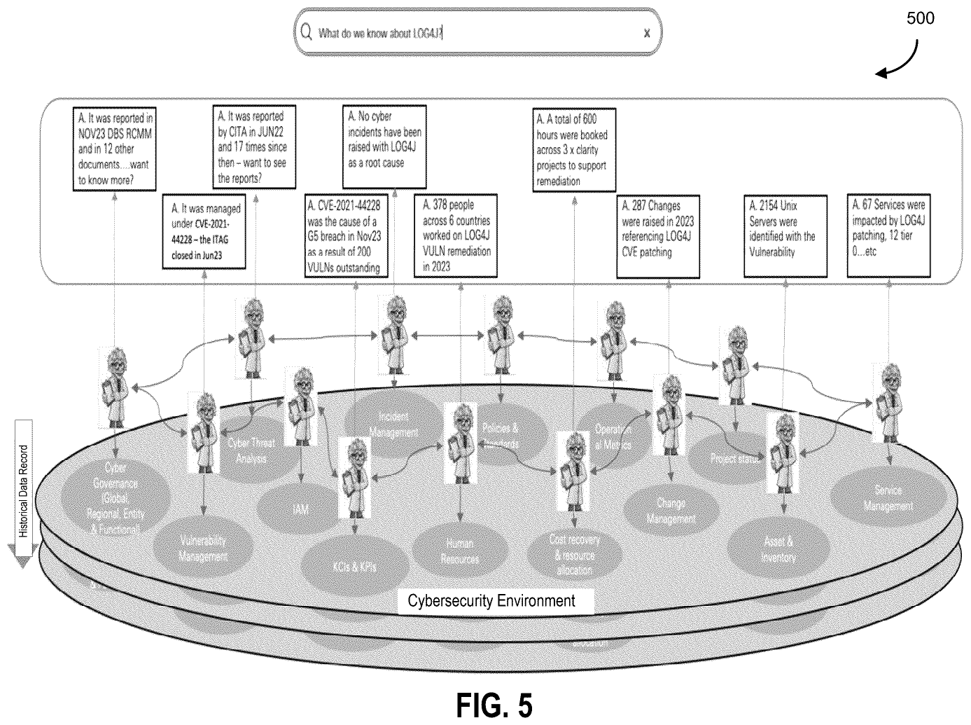

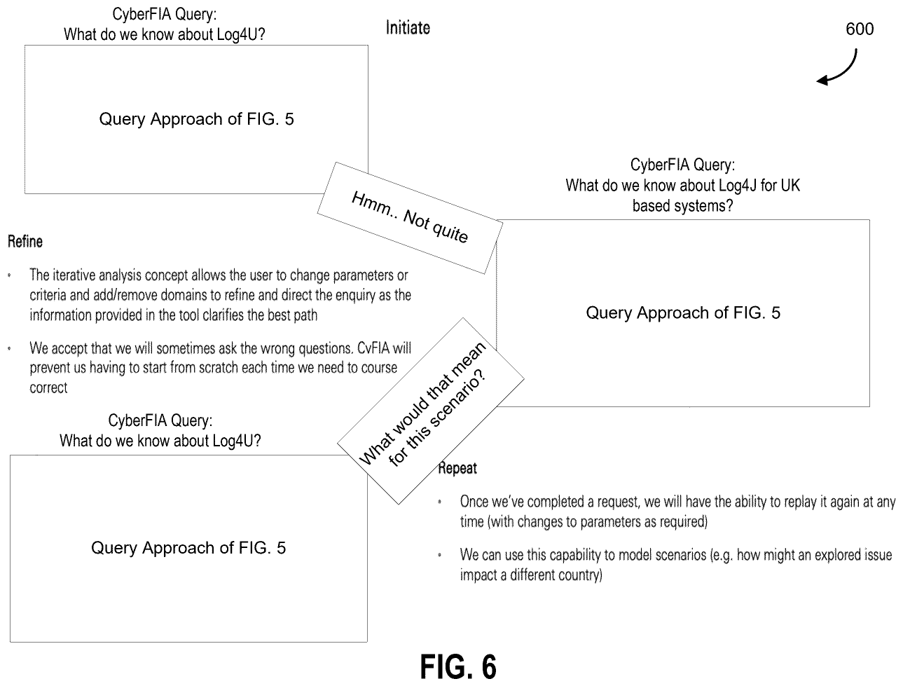

With approved access, application users submit questions or perform searches, for example such as a query string shown in FIG. 5. Submissions can be organized into JSON payloads that are passed to the application server main through a API REST endpoint. The application server can be containerized. In an embodiment, user inquiries are then passed to the Governance Accountability Engine 402 layer as shown in FIG. 4. These inquiries are validated by the Injection Protection Module 404. The Governance Accountability Engine 402 can include a query handler engine 404, an enterprise message bus 406, and various AI-driven agents.

These agents can include the query handler engine 404, which is configured to receive and/or handles stakeholder or user inquiries input into a user interface, such as “Where do we stand with vulnerability CVE-X-Y-Z?”. Input validation can be performed, and if the query string is valid, the system then begins by forwarding the inquiry to the Master Agent Controller 408 and logs the inquiry. In responding to the inquiry, the Master Agent Controller 408 interoperates with the secondary agents through the enterprise message bus 406, and ultimately, the query handler engine 404 provides response information back to the requesting stakeholder or user through the user interface. The response information can be represented as data objects or a rendered visualization, and may be automatically be customized based on a description of the roles and responsibilities, and/or the preferences of the user.

The Master Agent Controller 408 is the main agent used to process stakeholder or user inquiries. The Master Agent Controller 408 is configured to utilize a LLM Service to 1) determine the context of the inquiry, 2) identify the best domain-level agents to respond to the inquiry accurately based on previous interactions and responses, 3) combine the responses of each domain-level agent to new inquiries, 4) invoke the Large Language Model Service to identify or generate the best comprehensive response to the inquiry based on the responses of each individual domain-level agent. Also, the Master Agent Controller 408 checks the domain-level agents' heartbeats and only routes inquiries to domain agents that are alive. Interactions with the domain-level agents take place via the enterprise message bus 406. Responses from the domain agents are collected by the Master Agent Controller 408 and routed to a Generative AI Service for summarization and recommendation for generating a final visualization output or a textual response output. A final response output is then sent back to the query handler engine 404, which can be configured to log all interactions.

Domain agents are specific trained agents that governs domain specific tasks on behalf of organization domain subject matter experts (SMEs). Domain SMEs can configure goals, rules, tasks, schedule, conditions, constraints for the domain agents they are set to administer. The Domain Agents, when routed an inquiry from the Master Agent perform their respective tasks needed to accurately respond to the inquiry. The task is mainly comprised of answering the inquiry per the bounds of the domain the agent is responsible for. The domain-level agent interoperates with the Large Language Model agent to support the understanding the meaning or context of the query. Interactions with the Master agent through the Master Agent Controller 408 take place via the enterprise message bus 406 by, for example, sending data messages. Logs all interactions. The multiple domain agents enable autonomous “separation of concerns” which helps enforce diverse instructions and facilitate specific behaviors.

As shown in FIG. 4, a specially configured system for hybrid multi machine learning agent orchestration for handling cybersecurity-related queries is proposed, where the Master Agent Controller 408 operates as the main orchestration engine that is effectively serving as a computational “chief of staff” that is able to adapt the user's query to generate sub-queries to individual domain specialist agents, that can have a diversity of skills and training. The domain agents can include differences in computational architectures, data feed (and variations thereof) so that agents represent different perspectives with different breadth/depth characteristics, as well as long/short term memory and recognition aspects.

The primary agent may also be tasked with privacy/privilege based cleaning of the responses to ensure that there is no information leakage that breaches a privilege/privacy consideration. Furthermore, due to the multi-domain and domain-specific expertise segregation, there may be secondary agents that are trained and tuned to track second/nth order events, such as situational change, acceleration, which allows for a greater level of machine learning analysis.

Table 1 highlights the goals, constraints, and conditions for each domain agent. The Human-in-the-loop (HITL) component provides an iterative feedback process whereby a human interacts with parts of the accountability plane producing sensitive GenAI algorithmically generated content. Human-in-the-loop allows SMEs to validate and/or change the outcome of content produced by GenAI.

| Domain | Example Configuration/ | | Data Feeds/ |
|---|---|---|---|
| Agent | Architecture | Constraints | Conditions |
| Cyber | Configured to track | Limited real-time view | Periodic heartbeat checks to |
| Governance | overall adherence to | | check group policies, settings |
| | governance standards and | | |
| | protocols | | |
| Incident | Specialized for generating | Limited real-time view as | Receives data feeds triggered |
| Management | point in time outputs | incidents may be | whenever an incident is |
| | relating to point in time | | raised, the data feeds |
| | incidents. | | including temporally |
| | | | proximate data objects. |
| Asset | Specialized for generating | Limited real-time view as | Receives data feeds triggered |
| Inventory | point in time outputs | point in time inventory | whenever asset configuration |
| | relating to point in time | snapshots may become out of | or inventory item is added/ |
| | snapshots of inventory. | date. | deleted/ replaced. |
| | | | Maintains point in time |
| | | | inventory snapshots in |
| | | | storage. |
| Cost Recovery | Specialized for load | Real-time view but limited | Receives real-time batch |
| & Resource | management and process | storage so prone to | process based outputs relating |
| Allocation | load routing and task | catastrophic forgetting | to data process execution and |
| | allocations. | | allocation between different |
| | | | computing resources. |
| Human | Specialized for service | Real-time view but limited | Receives human task |
| Resources | ticket management and | storage so prone to | assignment data for assigning |
| | tracking incident/ | catastrophic forgetting. | service ticket data objects for |
| | vulnerability/ | Human free form notes may | humans to investigate or |
| | investigation remediation, | be inconsistent or | remediate problems. |
| | as well as notes. | inconclusive | |
| Cyber Threat | Configured to track new | Limited real-time view as | Receives real-time feed from |
| Intelligence | threats based on CVE | CVE data obtained only | external vulnerability database |
| | data objects. | periodically or triggered | identifying vulnerability |
| | | when new CVE becomes | characteristics and |
| | | available. | fingerprints. |
| Operational | Specialized for tracking | Real-time view but limited | Receives real-time low-level |
| Metrics | process/inventory | storage so prone to | performance/operational |
| | performance. | catastrophic forgetting | metrics, such as throughput, |
| | | | temperature, load, power |
| | | | levels. |
| Policies & | Configured to track | Limited real-time view | Periodic heartbeat checks to |
| Standards | overall adherence to | | check group policies, settings |
| | governance standards and | | |
| | protocols | | |
| Vulnerability | Configured to track new | Limited real-time view as | Processes periodic inventory |
| Management | vulnerabilities based on | vulnerability management is | snapshots and operational |
| | the identified CVE data | based on periodic snapshots | metrics (e.g., weekly feed), as |
| | objects. | to avoid overloading | well as incident management |
| | | memory/storage constraints. | feeds to track open and closed |
| | | | vulnerabilities. |
| Project Status | Specialized for tracking | Real-time view but limited | Receives real-time low-level |
| | project performance. | storage so prone to | project metrics, such as |
| | | catastrophic forgetting | deployment status, test |
| | | | performance, security audit |
| | | | validation. |
| Service | Specialized for tracking | Real-time view but limited | Receives real-time low-level |
| Management | environment deployments | storage so prone to | environment deployments and |
| | and service deployments. | catastrophic forgetting | service deployments, such as |
| | | | deployment status, test |
| | | | performance, security audit |
| | | | validation. |

As shown in Table 1, each of the domain agents can be different trained agents that are specialists for a specific type of query, has a specialized architecture (e.g., using transformer models, CNNs, RNNs), has specialized types of input data, as well as different performance constraints, which can be informed by or a function of their specialized architecture. The agents tabulated on Table 1 are not limited to this set and can be expanded for Cybersecurity, and for different industries or domain usages, there could be different agentic examples.

In some embodiments, the domain agents themselves are multiplied such that there are multiple domain agents for the same task, albeit with different architectures, or technical characteristics. For example, there can be three agents that are used for operational metrics, a first agent that tracks operational metrics in real-time (and is thus very prone to catastrophic forgetting given the amount of new data that requires processing), a second agent that tracks operational metrics on a daily feed basis (and is more capable of generating broader system-level insights at the cost of temporal currency of data), a finally, a third agent that tracks operational metrics on an exception feed basis, only tracking operational metrics that are out of boundaries, beyond a reference range, or marked with a high level of criticality (and thus being more capable for incident/issue diagnoses, at the cost of visibility into normal operating conditions).

The master agent, as described below, can be configured to send a query string to all three or a subset of these agents in an attempt to obtain a more accurate or useful response that can be ranked or combined together in generating the final output, allowing different configurations of models, their strengths, and weaknesses, to be overcome through the agents working together in concert.

A second example set of agents is shown in Table 2. In this variation, it is shown that each can have potentially different resources, communication protocols, sensors, among others. Other variants are possible. As noted herein there can be different architectures. In some embodiments, multiple variants of a same agent with different architectures or training approaches can be used simultaneously to elicit different responses, taking advantages of differences in architectures in an ability to explain or generate useful responses. This also allows for technical weaknesses of particular agent architectures or training approaches to be addressed by having a multiplicity of agents.

| | | Goals/Preferences/ | Communication |
|---|---|---|---|
| Agent | Abilities | Architectures | Protocol |
| Distributed Datastore | Interacts with cloud-agnostic | Integrate w/distributed | Binary->TLS-> |
| | distributed data store and CyFia | datastore | TCP |
| | agents | Execute CRUD ops | |
| | | Communicate integration | |
| | | issues | |
| | | CNN | |
| Data Processing | Ingests, transforms, enriches, | Interact with Datastore | Binary->TLS-> |
| | and persists data | agent for CRUD ops | TCP |
| | | Take agent CRUD op | |
| | | requests | |
| | | CNN | |
| Cyber Governance - | Respond to prompts & provide | Interact w/agents | Binary->TLS-> |
| (Global, Regional, | responses for Cyber | LSTM | TCP |
| Entity & Functional) | Governance domain | | |
| Cyber Threat | Respond to prompts & provide | Interact w/agents | Binary->TLS-> |
| Intelligence | responses for Cyber Threat | LSTM | TCP |
| | Intelligence domain | | |
| Vulnerability | Respond to prompts & provide | Interact w/agents | Binary->TLS-> |
| Management | responses for Vulnerability | LSTM | TCP |
| | Management domain | | |
| Incident Management | Respond to prompts & provide | Interact w/agents | Binary->TLS-> |
| | responses for Incident | LSTM | TCP |
| | Management domain | | |
| Policies & Standards | Respond to prompts & provide | Interact w/agents | Binary->TLS-> |
| | responses for Policies & | Transformers | TCP |
| | Standards domain | | |
| Operational Metrics | Respond to prompts & provide | Interact w/agents | Binary->TLS-> |
| | responses for Operational | CNN | TCP |
| | Metrics domain | | |
| Change Management | Respond to prompts & provide | Interact w/agents | Binary->TLS-> |
| | responses for Change | RNN | TCP |
| | Management domain | | |
| Project Status | Respond to prompts & provide | Interact w/agents | Binary->TLS-> |
| | responses for Project Status | LLM | TCP |
| | domain | | |
| Human Resources | Respond to prompts & provide | Interact w/agents | Binary->TLS-> |
| | responses for Human Resources | LLM | TCP |
| | domain | | |
| Cost Recovery & | Respond to prompts & provide | Interact w/agents | Binary->TLS-> |
| Resource Allocation | responses for Cost Recovery & | LLM | TCP |
| | Resource Allocation | | |
| | domain | | |
| Asset & Inventory | Respond to prompts & provide | Interact w/agents | Binary->TLS-> |
| | responses for Asset & | RNN | TCP |
| | Inventory domain | | |
| Service Management | Respond to prompts & provide | Interact w/agents | Binary->TLS-> |
| | responses for Service | LLM | TCP |
| | Management domain | | |

FIG. 5 is a pictogram showing example response strings generated by different computing agents, according to some embodiments. A string is received, and in this simplified example, the master agent broadcasts the query string to all of the individual domain agents. Each of the domain agents generates a candidate response, which, in some embodiments, can include coupled metadata, such as a confidence score for the response, based on the trained model of the domain agent. As shown in the example 500, each of the agents responds with drastically different string responses, and this is because each of the agents has different underlying computational architectures, different storage, different constraints, and different configurations. The master agent is configured to collate all or a subset of the responses to generate a combined response output string based on a combination of relevancy to the query question being posed/confidence scores, as well as identified characteristics of the requester, such as job profile descriptions obtained from an active directory profile associated with the requester, for example.

For example: for a query concerning operational metrics in the context of a professional looking for exceptions, Agent i, after cleaning and normalising the stringQuery, would route it to all Agents j trained on operational data and after receiving the messages back would use its policy set to prioritize the output from Agents j providing the latest and the ones providing the most reliable information; Agent i would then summarize the messages from the selected Agents j into succinct textual output and present individual messages in the format as defined by Agents j policy sets—in the table format, for example, in case of Agent j trained on the latest operational metrics.

In some embodiments, the job profile description is a string that is used in an intermediate prompt to a visualization engine, which is configured to generate the final visualization output, such as a dashboard, based on the active directory profile associated with the requester and the most relevant responses, ranked based on the active directory profile. An individual tasked with individual environment remediation tasks, such as updating outdated packages with a particular vulnerability may be provided with a dashboard of individual Log4J vulnerable endpoints and their remediation status, whereas a cybersecurity governance manager may be provided with a dashboard showing a summary level of the percentage of vulnerable endpoints and their overall remediation process, for example.

The output visualization, in some embodiments, is tagged with data lineage metadata generated based on the data source inputs of the underlying agents whose responses were selected for combination into the visualization output, such that a user, upon reviewing the dashboard, is able to investigate the underlying data sets and identify limitations (e.g., obtained from a non-real-time weekly batch data feed).

FIG. 6 is a pictogram showing a variant embodiment where iterative analysis is utilized for query replay and scenario tracking, according to some embodiments. The approach 600 shown in FIG. 6 includes the ability to replay or modify parameters of a search, for example, and previous response outputs can be maintained in memory by the master agent to modify how the master agent selects the subset of domain specific responses or combines them together for output.

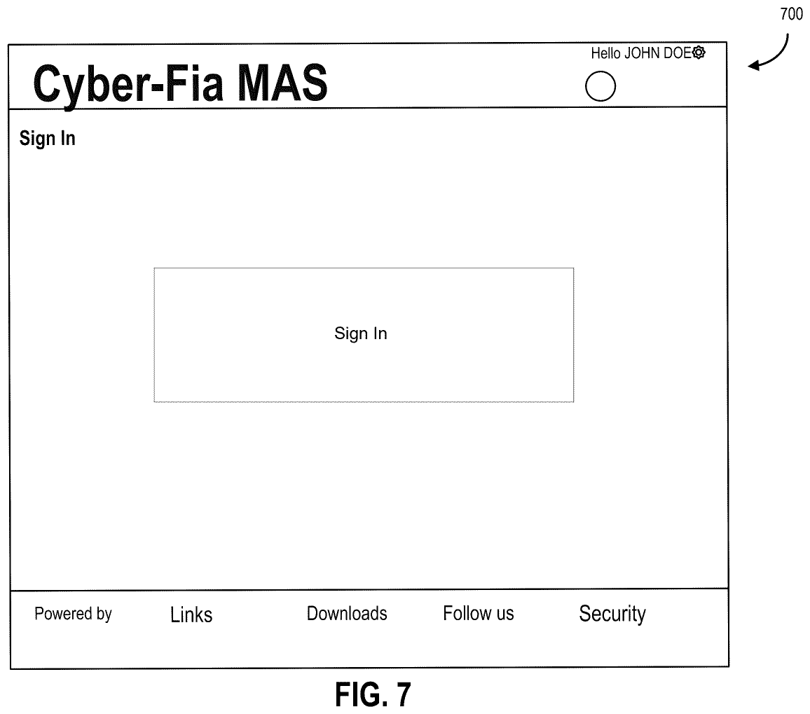

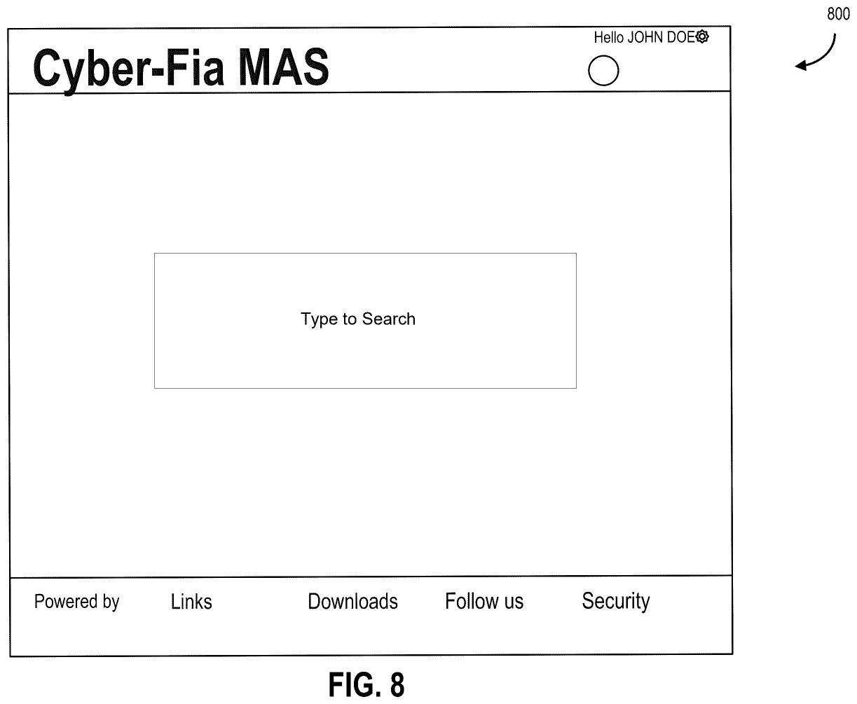

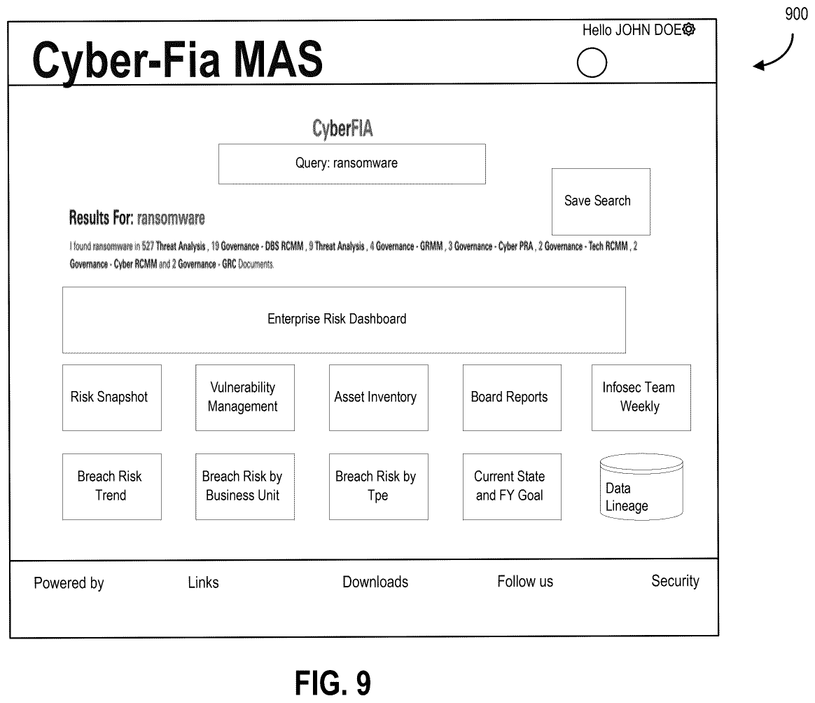

FIG. 7, FIG. 8, FIG. 9 show example user interface screens, according to some embodiments. In FIG. 7, stakeholder users, from their computing devices, outfitted with a web browser, may be requested to visit a secured agent access web URL provided by the administrator of the system. HTTPS/TCP can be used for communication between the users and the system. FIG. 7 shows a sign in page 700. The system can be hosted on a shared computing backend, such as by a specific server residing within a data center and configured to handle incoming user query strings received over a message bus, for example. A users attempts to sign into the system with their account credentials via the sign in page. Accounts may need to be set up and approved by a system administrator. Accounts are setup and configured within the cloud provider's ecosystem. Application role-based access control is can also be conducted in accordance with permissioned policies. Views of the web presentation layer can be implemented on a combination of HTML, JavaScript, Cascading Style Sheet, among others. FIG. 8 shows an example search bar 800 where the user is able to interface with the system to input a query. FIG. 9 shows an example results page 900 that is a customized visualization generated as a response to the query.

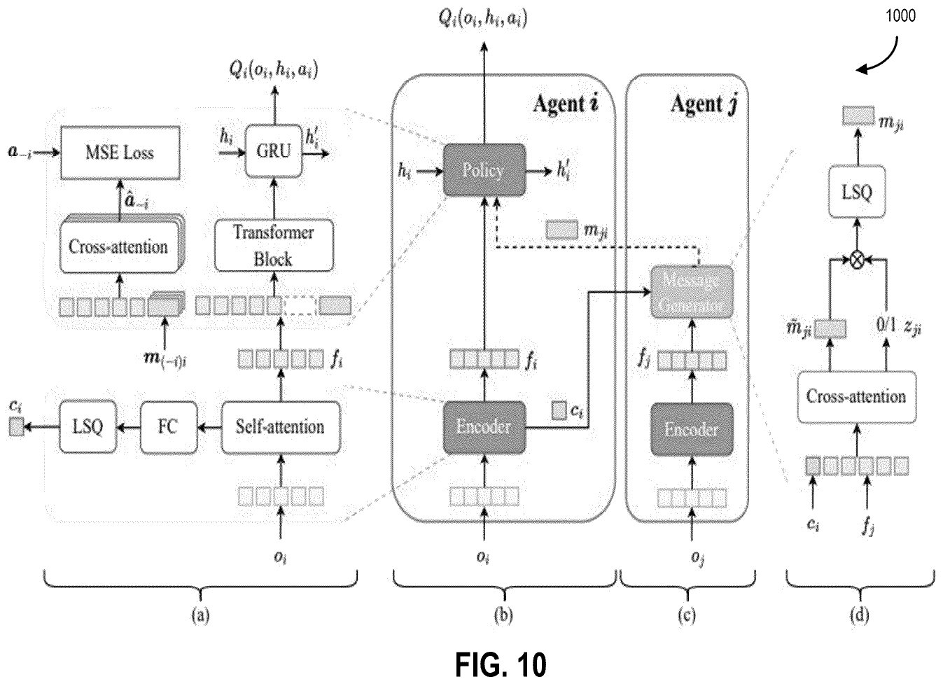

FIG. 10 is a block schematic showing an example machine learning/artificial intelligence network architecture, according to some embodiments. FIG. 10 depicts an example of the AI multi-agent system network architecture 1000.

In FIG. 10, it shows at (a), a feature encoder and policy network, at (b) architecture for a CyFia agent i, at (c), architecture for a CyFia agent j, and at (d), a message generator. These components are interconnected and link together for agent ranking, broadcast message generation, specific response generation, and consolidation of responses. As noted herein, the agents can be interconnected and provide sub-queries to one another as well as sub-query responses. The architecture helps agents with policy management, context and attention handling that is required for accurate answers. The network architecture includes, the system feature encoder and policy network, model architecture for agents i and j, in this example, as well as a message generator engine. In some embodiments, human SME's can have control over setting the goals, constraints, conditions and additional properties of the domain agents, and make them available to the system.

The network architecture consists of independent computing processes or daemonsets used to take encoded stringQuery and system inputs to determine relevancy and importance in responding to user stringQueries.

Machine or deep learning architectures, including, for example, recurrent neural networks and/or transformers can be used to process data in an effort to retain or remember previous inputs in support of understanding the current one. For instance, gates used to support decisioning on which information is relevant/important and to retain or forget. Transformers are used to support cross-attention as all inputs or sequences can be processed together. Comparisons of each sequence token are performed to determine relevancy and importance.

Agent i, master agent, takes stringQueries which are cleansed to ensure no injection of malicious payloads and normalized for processing. Transformed stringQueries are analyzed against a configurable and trainable policy set. Policy represents a network function used to support master agent decision making and decision enforcement. The policy includes execution of algorithms that evaluate prioritisation tasks, measure reliability scores, carry out conflict resolutions, convert the final data output into the format as dictated by the policy set.

The policy network can be configured at system start and is tailored for a particular system use case, such as Cybersecurity. Tailoring consists of encoding or preparing stringQuery and system data for machine learning algorithms requiring numerical analytics. Encoding techniques (e.g., one-hot encoding) can be used to provide the optimal numerical representation. Least Square (LSQ) or learned step quantization techniques can be embedded or used for embeddings.

The master agent leverages its policy based decisions to determine which domain specific agent or a combination of agents should be routed the stringQuery which is presented in its encoded form.

Agent j's or domain agents running as separate processes or daemonstates that leverage machine learning algorithms to best support responding to the inquiry from Master agent. Responses are generated as messages which are then analyzed by the Agent i against its dynamic policy network to ensure the provided domain agent responses meet priorization, reliability scores, and conflict resolution rules or information.

Once Agent i has completed its policy analysis, the selected responses are combined, summarized, and presented in a multimodel output by leveraging trained policy-sets for Agents j's preferred or optimal data representation formats and templates.

An example use case pseudocode can be established for threat intelligence:

```
# Initialize the agent with RAG capabilities agent = Agent(
  agent_name=“Threat-Intelligence-Agent”,
  system_prompt=THREAT_INTELLIGENCE_AGENT_SYS_PROMPT,
  agent_description=“Agent curates threat intelligence information and responds to
inquiries”,
collaborators= [datalake_agent, external_interface_agent, red_team_agent],
  llm=model,
  max_loops=“auto”, # Auto-adjusts loops based on task complexity
  autosave=True, # Automatically saves agent state
  dashboard=False, # Disables dashboard for this example
  verbose=True, # Enables verbose mode for detailed output
  streaming_on=True, # Enables streaming for real-time
  processing
  dynamic_temperature_enabled=True, # Dynamically adjusts temperature for
optimal performance
  saved_state_path=“threat_intelligence_agent.json”, # Path to save agent state
  user_name=“threat_intelligence_corp”, # User name for the agent
  retry_attempts=3, # Number of retry attempts for failed tasks
  context_length=200000, # Maximum length of the context to consider
  long_term_memory=chromadb, # Integrates ChromaDB for long-term
  memory
management
  return_step_meta=False,
  output_type=“string”,
) # Run the agent with a sample task
agent.run( “What are the components of a startup's stock incentive equity plan” )
```

Another example is provided that can be used for the configuration of the Head of Cybersecurity Governance agent.

### # Initialize the Head of Cybersecurity Governance Agent

```
head_cybersec_gov = Agent(
  agent_name=“Head of Cybersecurity Governance”,
  system_prompt=f“““
  As the Head of Cybersecurity Governance at {company}, your role is to
oversee the entire Cybersecurity Governance organization.
  Your responsibilities include:
  1. Setting the overall strategy and direction for the organization
  2. Coordinating the efforts of the various team members and ensuring a
comprehensive evaluation
  3. Reviewing the findings and recommendations from each team
  member
  4. Making the final decision on whether to proceed with the acquisition
For the current potential acquisition of {company}, direct the tasks for the
team to thoroughly analyze all aspects of the company, including its
governance, position, technology and regulatory compliance. Provide
guidance and feedback as needed to ensure a rigorous and unbiased
assessment.
  ”””,
  llm=model,
  max_loops=1,
  dashboard=False,
  streaming_on=True,
  collaborators= [lead_cybersec_gov, regulator_response_agent,
  global_ciso_agent],
  verbose=True,
  stopping_token=“<DONE>”,
  state_save_file_type=“json”,
  saved_state_path=“head-cybersecurity-governance.json”,
)
```

In both examples, agents' collaborators can be set which gives human subject matter experts ability to define collaboration.

The large language model agent is configured for providing inquiry contextual information, summarizing content, providing recommendations based on the combined inquiry responses of the domain agents. This agent provides service functions that are configured to be very capable tasks solvers. The large language model agent returns content matching the meaning of a query. In a cybersecurity governance example, the orchestration nature of the agents also makes it possible to run, manage, and scale multiple parts of AI models independently in the context of one application, with much greater control over individual pieces and life cycles.

The underlying processes are all controlled and monitored by the master agent. A challenge is that with many LLMs, the knowledge can be too domain non-specific and produce noise. This approach helps tune/tailor organizational data so context has increased accuracy the context is not muddled by extraneous information not related to the organization. The large language model agent provides specific data inputs, such as metadata, that can be used to tailor AI agents on specific organization knowledge so the secondary AI agents have an increased understanding language, intent, context and issues specific to an organization's governance, risk and compliance, through generating accompanying metadata to be used as input signals. The approach allows organizations to tailor their data, policies, and procedures to tailoring the LLMs for improved accuracy, and provides ability for administrators to configure the AI agents. The LLM agent, in some embodiments, can be configured to have access to the knowledge source through interactions with the distributed data store agent. This helps with providing current and past ground truth. The large language model agent supports the master agent coordinator 408 in accurately responding to stakeholder and user inquiries. The large language model agent uses semantic (vector) search algorithms to facilitate a broader search surface enabling a more intuitive search experience where, for example, the query's context and intent yield results.

The enterprise message bus 406 is a centralized information hub that provides an integration point between agents. Bus messages can be Javascript Object Notation (JSON) formatted but other variations are possible. Agents can share information and publish notifications on the bus. For instance, health checks notifications are published/consumed on this bus. In addition, a system-specific message is published on this bus to provide system-wide notices.

The distributed data store agent is an example agent that can be configured for read/write interactions with a distributed data store. Agents communicate with this agent, via the message bus, to perform those reads and writes. The distributed data store agent interacts with a cloud provider's distributed data store solution. The agent is equipped with API adapters that allow for connectivity and communication with the cloud provider distributed data store. Read and write operations are logged.

The data asset discovery agent is an example agent that can be configured for the discovery of the organization's data assets. This agent governs an independent process to help discover data that provides facts about an aspect of the organization's environment. This agent is configured to interact with the organization's data catalog platform and tooling that is used to understand and manage their data assets. With this integration to the data catalog platform, this agent automatically acquires updates on the inventory of data assets, particularly their metadata.

The external interface agent is an example agent that can be configured for interactions with knowledgebase resources external to the organization, e.g., Google, NIST. Interactions are facilitated via routes like API/REST.

The accountability scoring component engine is a computer module that is configured to provide an accountability scoring methodology used to assign numerical values to key components of accountability like vulnerability, threats, and incidents. This can help to compare and rank different options or outcomes. After receiving the completed context aware inquiry response from the Large Language Model Service, the Master Agent, through the Master Agent Controller 408 returns the response to the stakeholder/user. Inquiry responses are presented in a web portal, shown in FIG. 6 and FIG. 7.

In some embodiments, the multi agent orchestration system, for example, used for cybersecurity governance system is containerized or bundled with all applications code, files and libraries it needs to run on any infrastructure, e.g., cloud provider, such that the system can be provided as a special purpose machine instance that is able to link into one or more message buses, train underlying secondary agents on historical or current data feeds, and utilize the trained agents during inference time when a query is received. The special purpose machine instance can reside in a data center, and in some embodiments, is a specialized computing appliance, such as a rack mounted appliance, that couples to the enterprise message bus. A set of hybrid master/secondary agents are provided and maintained on local storage, and are automatically trained using received data sets from across the network. For a cybersecurity example, this can include different cybersecurity data feeds, such as incident reports, alerts, environment configuration files, heartbeat messages, load characteristics, among others. The system can be configured for generation automated query responses when the special purpose machine instance receives query strings from different user interfaces, automatically generating visualizations or other data outputs for rendering on one or more user interfaces. In some embodiments, the special purpose machine instance can also couple to an active directory instance to automatically obtain permissions, privileges, and user type information for a particular user, such that the master agent is able to provide metadata to the generation engine such that the automatically generated visualizations or other data outputs are selected and tuned for the specific user's profile. In another embodiment, search history and preferences can also be obtained and used for tuning.

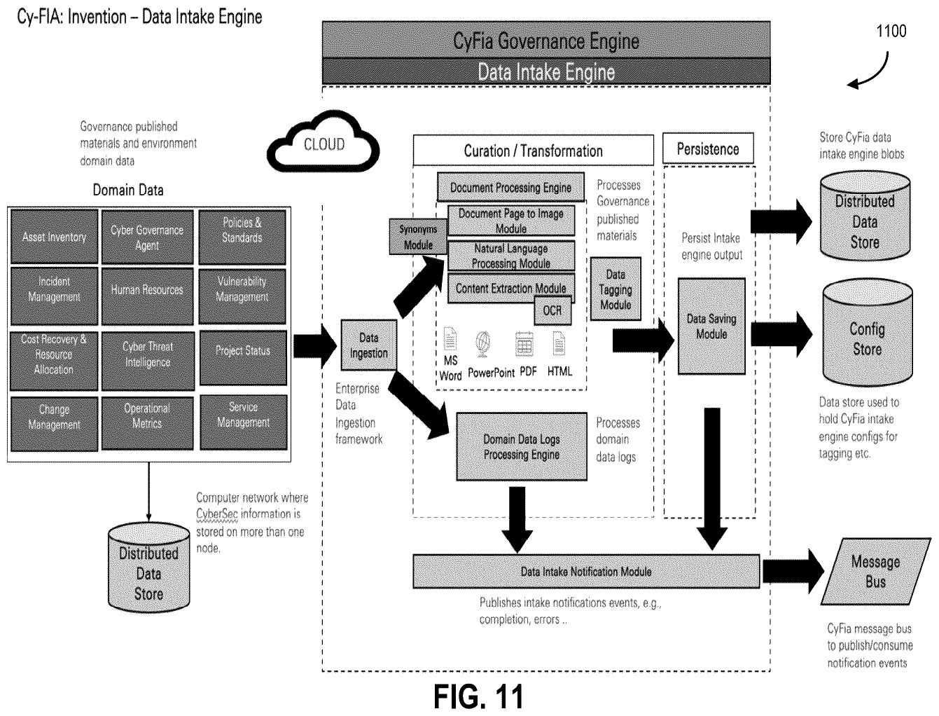

FIG. 11 is a block schematic diagram illustrating the functional components of an example data intake engine, according to some embodiments. As shown in FIG. 11, the data intake engine 1100 provides the computing infrastructure for obtaining computing networking, security, monitoring and configuration data that are used in a computing ecosystem. The computing ecosystem for an enterprise, is used among others, for connectivity between the users, the proposed system, and the distributed data/quality processing systems are monitored for performance and cybersecurity vulnerabilities.

Enterprise data representing real events associated with each domain is stored in a distributed data store through existing organizational data engineering processes. The proposed system, at a minimum, focuses on the following domain-level data which represents “on the ground” facts: Policies & Standards, Cyber Governance published materials, Threat Intelligence, Vulnerability Management, Incident Management, Operational Metrics, Change management, Human resources, Cost Recovery & Resource Allocation, Asset & Inventory, and Service Management, among others.

The data intake engine 1100 can be configured as a long-running data pipeline service or data process, such as a persistent data daemon function, processes domain-level data leveraging existing enterprise data ingestion frameworks. The engine operates in a cloud provider's environment and can be containerized. The data intake engine 1100 can include a data ingestion module, a data processing engine, a content extraction module, among others.

The data ingestion module polls the distributed data store for any new or updated domain-level data events. Polling or the frequency at which the module seeks new information is configurable. Data events that are document blobs are forwarded to the document processing engine. All other events are passed to existing enterprise curation and transformation routines used to normalize the data.

The document processing engine processes blobs with file formats like ms-Word, PowerPoint, pdf, html which are used in governance organizations to communicate accountability posture to internal and external stakeholders. These blobs or document file formats go through the following processing regime. The content extraction module, for each document, extracts key document elements such as the headings, paragraphs, links, tables, and images. For each document element instance, a unique identifier is created and used in building relations amongst the elements.

Moreover, document metadata is captured. Metadata such as the document type, file format, tags, author, contributors are captured and ultimately used in accurately answering user's inquiries. During the content extraction sub-process, an optical character recognition engine identifies tables and similar objects and extracts them per document. The natural language processing (nlp) module provides term frequency distribution, text summarization, keyword search, and tokenization calculations. These calculations are provided for each document. Nlp techniques are also used to generate synonyms and grammatical variations. Leveraging word2vec which is shallow neural network that takes every word in the desired corpus as input, uses a single large hidden layer, commonly 300 dimensions, and then attempts to predict the correct word from a softmax output layer based on the type of word2vec model (cbow or skip gram). The synonyms and grammatical variations are regularly updated and up-serted into data storage layer. The synonyms and grammatical variations support input auto-completion and semantic searching using generative AI transformers.

The document page to image module produces an image for each document page. The document tagging module consists of logic used to improve document searchability and organization. This sub-process identifies existing document tag metadata and extracts them out. In addition, this sub-process analyzes the document leveraging nlp to determine term importance and weight in identifying document tags. Following the curation/transformation step, captured document information persisted to the distributed data store. Notification message events are published to the message bus via the data intake notification engine. Events such as the start or completion of data intake or errors that may have occurred during intake are published on the bus.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or combinations thereof.

The functional blocks and modules described herein may comprise processors, electronics devices, hardware devices, electronics components, logical circuits, memories, software codes, firmware codes, etc., or any combination thereof. In addition, features discussed herein may be implemented via specialized processor circuitry, via executable instructions, and/or combinations thereof.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term).

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed embodiment, the term “substantially” may be substituted with “within [a percentage] of” what is specified, where the percentage includes 0.1, 1, 5, and 10 percent; and the term “approximately” may be substituted with “within 10 percent of” what is specified.

The phrase “and/or” means and or. To illustrate, A, B, and/or C includes: A alone, B alone, C alone, a combination of A and B, a combination of A and C, a combination of B and C, or a combination of A, B, and C. In other words, “and/or” operates as an inclusive or. Additionally, the phrase “A, B, C, or a combination thereof” or “A, B, C, or any combination thereof” includes: A alone, B alone, C alone, a combination of A and B, a combination of A and C, a combination of B and C, or a combination of A, B, and C.

The terms “comprise” and any form thereof such as “comprises” and “comprising,” “have” and any form thereof such as “has” and “having,” and “include” and any form thereof such as “includes” and “including” are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any implementation of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, it will be understood that the term “wherein” may be used interchangeably with “where.”

Further, a device or system that is configured in a certain way is configured in at least that way, but it can also be configured in other ways than those specifically described. Aspects of one example may be applied to other examples, even though not described or illustrated, unless expressly prohibited by this disclosure or the nature of a particular example.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a processor, a digital signal processor (DSP), an ASIC), a field programmable gate array (FPGA) or other programmable logic device, discrete gate or transistor logic, discrete hardware components, or combinations thereof designed to perform the functions described herein. A processor may be a microprocessor, but in the alternative, the processor may be another form of processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a computer, or a processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

The above specification and examples provide a complete description of the structure and use of illustrative implementations. Although certain examples have been described above with a certain degree of particularity, or with reference to one or more individual examples, those skilled in the art could make numerous alterations to the disclosed implementations without departing from the scope of this invention. As such, the various illustrative implementations of the methods and systems are not intended to be limited to the particular forms disclosed. Rather, they include all modifications and alternatives falling within the scope of the claims, and examples other than the one shown may include some or all of the features of the depicted example. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several implementations.

The claims are not intended to include, and should not be interpreted to include, means plus- or step-plus-function limitations, unless such a limitation is explicitly recited in a given claim using the phrase(s) “means for” or “step for,” respectively.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A computer system adapted for providing a multi-domain primary computational conversation agent, the computer system comprising:
a computer processor operating in conjunction with computer memory and a non-transitory computer data storage, the computer processor configured to:
maintain the multi-domain primary computational conversation agent configured to receive a main query string, from a user having a user type and user profile fields, the multi-domain primary computational conversation agent coupled to a plurality of secondary domain specialized computational conversation agents;
broadcast a subquery message to the plurality of secondary domain specialized computational conversation agents;
receive one or more response data messages from each of the secondary domain specialized computational conversation agents, each data message including a combination of a proposed response string, and a corresponding confidence score value;
process each of the proposed response string and the corresponding confidence score values to generate a candidate score for each of the proposed response strings based on the multi-domain primary computational conversation agent scoring based on the user type and user profile fields from the querying party;
combine at least two of the proposed response strings to generate a combined response string using a coupled trained large language model; and
output the combined response string as a rendered data object on a coupled user interface instance for rendering on a device associated with the user.

2. The system of claim 1, wherein the plurality of secondary domain specialized computational conversation agents are trained machine learning models each having different feed sources and feed parameter characteristics coupled to one or more data source feed sources.

3. The system of claim 1, wherein the plurality of secondary domain specialized computational conversation agents are trained machine learning models each having different neural network architectures or each having different domain specializations.

4. The system of claim 1, wherein prior to rendering the rendered data object, the combined search string or the rendered data object is provided to an intermediate reviewer user interface provided to a human reviewer for awaiting provisioning of an approval signal, the approval signal triggering the rendering on the device associated with the user.

5. The system of claim 1, wherein the user type and the user profile fields are obtained from an active directory server, and the generation of the combined response string using the coupled trained large language model includes additionally providing the user type and the user profile fields as additional data payloads to the coupled trained large language model.

6. The system of claim 5, wherein the broadcast of the subquery message includes including the additional data payloads to the subquery message in addition to the main query string.

7. The system of claim 3, wherein the different neural network architectures includes agents that are trained with a same set of data sources but the different neural network architectures are configured with different activation or input layers tracking different derivatives of data from the same set of data sources.

8. The system of claim 7, wherein the different derivatives of data from the same set of data sources include a real-time data feed, and one or more derivations based on higher order rates of changes of data elements from the real-time data feed.

9. The system of claim 7, wherein the different derivatives of data from the same set of data sources include a real-time data feed, and one or more derivations based on aggregations of data in the real-time data feed.

10. The system of claim 1, wherein the computer system is a special purpose computing appliance residing in a data center and coupled to a message bus receiving data feeds from one or more computing endpoints indicative of computing asset inventory and operational metrics, and the special purpose computing appliance is configured to receive the main query string from the message bus and to output the combined response string on the message bus.

11. A computer method adapted for providing a multi-domain primary computational conversation agent, the computer method including:
maintaining the multi-domain primary computational conversation agent configured to receive a main query string, from a user having a user type and user profile fields, the multi-domain primary computational conversation agent coupled to a plurality of secondary domain specialized computational conversation agents;
broadcasting a subquery message to the plurality of secondary domain specialized computational conversation agents;
receiving one or more response data messages from each of the secondary domain specialized computational conversation agents, each data message including a combination of a proposed response string, and a corresponding confidence score value;
processing each of the proposed response string and the corresponding confidence score values to generate a candidate score for each of the proposed response strings based on the multi-domain primary computational conversation agent scoring based on the user type and user profile fields from the querying party;
combining at least two of the proposed response strings to generate a combined response string using a coupled trained large language model; and
outputting the combined response string as a rendered data object on a coupled user interface instance for rendering on a device associated with the user.

12. The method of claim 11, wherein the plurality of secondary domain specialized computational conversation agents are trained machine learning models each having different feed sources and feed parameter characteristics coupled to one or more data source feed sources.

13. The method of claim 11, wherein the plurality of secondary domain specialized computational conversation agents are trained machine learning models each having different neural network architectures or each having different domain specializations.

14. The method of claim 11, wherein prior to rendering the rendered data object, the combined search string or the rendered data object is provided to an intermediate reviewer user interface provided to a human reviewer for awaiting provisioning of an approval signal, the approval signal triggering the rendering on the device associated with the user.

15. The method of claim 11, wherein the user type and the user profile fields are obtained from an active directory server, and the generation of the combined response string using the coupled trained large language model includes additionally providing the user type and the user profile fields as additional data payloads to the coupled trained large language model.

16. The method of claim 15, wherein the broadcast of the subquery message includes including the additional data payloads to the subquery message in addition to the main query string.

17. The method of claim 13, wherein the different neural network architectures includes agents that are trained with a same set of data sources but the different neural network architectures are configured with different activation or input layers tracking different derivatives of data from the same set of data sources.

18. The method of claim 17, wherein the different derivatives of data from the same set of data sources include a real-time data feed, and one or more derivations based on higher order rates of changes of data elements from the real-time data feed.

19. The method of claim 17, wherein the different derivatives of data from the same set of data sources include a real-time data feed, and one or more derivations based on aggregations of data in the real-time data feed.

20. A non-transitory computer readable medium storing computer interpretable instruction sets, which when executed by a computer processor, cause the computer processor to execute a method providing a multi-domain primary computational conversation agent, the computer method including:
maintaining the multi-domain primary computational conversation agent configured to receive a main query string, from a user having a user type and user profile fields, the multi-domain primary computational conversation agent coupled to a plurality of secondary domain specialized computational conversation agents;
broadcasting a subquery message to the plurality of secondary domain specialized computational conversation agents;
receiving one or more response data messages from each of the secondary domain specialized computational conversation agents, each data message including a combination of a proposed response string, and a corresponding confidence score value;
processing each of the proposed response string and the corresponding confidence score values to generate a candidate score for each of the proposed response strings based on the multi-domain primary computational conversation agent scoring based on the user type and user profile fields from the querying party;
combining at least two of the proposed response strings to generate a combined response string using a coupled trained large language model; and
outputting the combined response string as a rendered data object on a coupled user interface instance for rendering on a device associated with the user.
